(19) United States
(12) Patent Application Publication
(10) Pub. No.: US 2025/0262685 A1
(43) Pub. Date: Aug. 21, 2025

(54) LASER WELDING METHOD AND LASER WELDING APPARATUS USED IN THIS METHOD

(71) Applicant: Prime Planet Energy & Solutions, Inc., Tokyo (JP)

(72) Inventor: Yusuke OKUHATA, Toyota-shi (JP)

(21) Appl. No.: 19/000,704

(22) Filed: Dec. 24, 2024

(30) Foreign Application Priority Data
Feb. 21, 2024 (JP) 2024-024407

(51) Int. Cl. B23K 26/067; B23K 26/21; H01M 50/169

(52) U.S. Cl. CPC B23K 26/067; B23K 26/21; H01M 50/169

(57) ABSTRACT

A laser welding method for laser-welding a first welding portion and a second welding portion by irradiation of a laser beam includes: a multi-beam generating step of generating a radially polarized multi-beam as the laser beam, composed of a plurality of beamlets, each of which is a radially polarized beamlet; and an irradiation welding step of laser-welding the first welding portion and the second welding portion by irradiating the radially polarized multi-beam to the first welding portion and the second welding portion and simultaneously moving an irradiation site.

### CROSS-REFERENCE TO RELATED APPLICATIONS

This application is based upon and claims the benefit of priority to Japanese Patent Application No. 2024-024407 filed on Feb. 21, 2024, the entire contents of which are incorporated herein by reference.

### BACKGROUND

### Technical Field

The disclosure relates to a laser welding method for laser-welding a first welding portion and a second welding portion by irradiation of a laser beam, and a laser welding apparatus used in this method.

### Related Art

A welding method for welding using a laser beam including a plurality of beamlets, which is a so-called multi-beam, has been known (see Japanese unexamined patent application publication No. 2021-159931 (JP 2021-159931A)).

### SUMMARY

### Technical Problems

This publication, JP 2021-159931A, does not consider the polarization direction of each beam. However, it has been found that, in laser welding, the ease of welding and so on also depends on the polarization directions of irradiated multiple beams.

The present disclosure has been made to address the above problems and has a purpose to provide a laser welding method capable of more quickly welding a first welding portion and a second welding portion with lower energy or more deeply melting and welding them with lower energy, than conventional methods, and a laser welding apparatus used in this method.

### Means of Solving the Problems

(1) To achieve the above-mentioned purpose, one aspect of the present disclosure provides a laser welding method for laser-welding a first welding portion and a second welding portion by irradiation of a laser beam, the method comprising: generating a radially polarized multi-beam as the laser beam, including a plurality of beamlets, each of the beamlets being a radially polarized beamlet; and generating a multi-beam as the laser beam, the multi-beam being a radially polarized multi-beam including a plurality of beamlets, each of the beamlets being a radially polarized beamlet; and laser-welding the first welding portion and the second welding portion by irradiating the radially polarized multi-beam to the first welding portion and the second welding portion and simultaneously moving an irradiation site of the radially polarized multi-beam.

It is known that, when light is irradiated to a metal plate made of for example iron or aluminum, the absorption rate of the light varies with the angle of incidence, i.e., the absorption rate is a function of incident angle. In addition, the functional relationship between the incident angle and the absorption rate differs between s-polarized light, which is linearly polarized light in which an electric field of incident light oscillates in a direction perpendicular to the incident plane, and p-polarized light, which is linearly polarized light in which an electric field of incident light, orthogonal to the s-polarized light, oscillates in a direction parallel to the incident plane. It is known that, the p-polarized light generally has an absorption rate equal to or larger than the s-polarized light over the entire incident range, and further the absorption rate is plotted on a graph that gradually increases as the incident angle increases and has a peak at an incident angle slightly smaller than 90 degrees (for example, in the vicinity of about 88 degrees when light with a wavelength of 1 μm is incident on an aluminum plate).

When a laser beam is irradiated to an irradiation site on a portion to be welded, referred to as a welding portion, e.g., the first welding portion and the second welding portion, melting the welding portion to generate a depressed hole (a keyhole), the incident angle of the laser beam on the surface of the depressed hole is large over the entire circumference of the hole. Here, when the laser beam to be irradiated is a radially polarized beamlet, the p-polarized light is incident on the surface of the hole over the entire circumference of the hole, so that the absorption rate further increases due to the increased incident angle, allowing the welding portion to be efficiently melted at the irradiation site. The radially polarized beamlet is one of axially symmetric polarized beamlets, and indicates a laser beam in which an optical electric field is radially generated in a radial direction around the beam center.

In the disclosure, in the process of generating the radially polarized multi-beam, the radially polarized multi-beam composed of the beamlets, which are also referred to as sub-beams, each of which is a radially polarized beamlet is generated. Then, in the process of laser-welding, the irradiation site is moved while the radially polarized multi-beam is irradiated to both the first welding portion and the second welding portion. Therefore, compared to when welding is performed using a multi-beam that has the same beam pattern but is not a radially polarized multi-beam, it is possible to more quickly weld the first welding portion and the second welding portion with lower energy or more deeply melt and weld them with lower energy.

The radially polarized multi-beam is a laser beam composed of a multi-beam including a plurality of beamlets, which are irradiated at different sites from each other on an irradiation plane to form a plurality of laser spots, and each beamlet is a radially polarized beamlet. Each of the beamlets forming the radially polarized multi-beam is a single-ring-shaped radially polarized beamlet whose beam intensity is distributed annularly, or at least one of the beamlets may be a double-ring-shaped double-concentric radially polarized beamlet.

Further, in the laser-welding process, the movement of the irradiation site may be performed by relative movement of the first welding portion and the second welding portion with respect to the laser beam. That is, the relative movement may be carried out by moving the laser beam, moving the first welding portion and the second welding portion, or moving all the laser beam and the welding portions.

Each of the first welding portion and the second welding portion is a portion to be welded, as a part of a member or component to be welded. Therefore, these portions also may include a first welding portion of a first welding member, a second welding portion of a second welding member, which is a separate component from the first welding member. Further, the above portions also may include a first welding portion of a single welding member and a second welding portion, which is a different area from the first welding portion in the same welding member. For example, in the case of a power storage device, an opening portion of a case body member may be set as the first welding portion and the circumferential edge portion of the lid closing the opening portion may be set as the second welding portion. As an alternative, a first edge portion of the case body member may be set as the first welding portion and a second edge portion of the case body member, different from the first edge portion, may be set as the second welding portion.

(2) In the laser welding method described in foregoing (1), generating the radially polarized multi-beam may include: obtaining one radially polarized single-beam; and branching the radially polarized single-beam to obtain the radially polarized multi-beam.

To generate the radially polarized multi-beam, the radially polarized beamlets, which are the beamlets, may be combined to generate the radially polarized multi-beam. However, a plurality of light sources for the radially polarized beamlets are required and an optical system for combining separate radially polarized beamlets tends to be complicated. In contrast, in the present technique, one radially polarized single-beam is obtained in advance in the process of obtaining a single beam and then the radially polarized multi-beam is obtained from the radially polarized single-beam in the branching process. This technique can therefore easily obtain the radially polarized multi-beam.

As the radially polarized single-beam obtained in the single-beam obtaining process, a single-ring-shaped radially polarized beamlet whose beam intensity is distributed annularly may be obtained, or a double-ring-shaped double-concentric radially polarized beamlet may be obtained.

A method for obtaining the radially polarized single-beam in the single-beam obtaining process may include for example a method for generating a radially polarized beam using a metal grating mirror formed with radial grooves as a total reflection mirror of a resonator (A. V. Nesterov, V. G. Niziev and V. P. Yakunin: “Generation of high-power radially polarized beam,” J. Phys. D: Appl. Phys., 32 (1999) 2871-2875.), a method for generating a radially polarized beam using a dielectric mirror (GIRO) which reflects only radial polarization light by use of a diffraction grating whose pitch is equal to or less than a wavelength (T. Moser, J. Balmer, D. Delbeke, P. Muys, S. Verstuyft and R. Baets: “Intracavity generation of radially polarized CO2 laser beams based on a simple binary dielectric diffraction grating,” Appl. Opt., 45 (2006) 8517-8522.). Further, the following methods may also be adopted: a method for generating a radially polarized beam by incorporating a dielectric multilayer mirror, which is composed of a multilayer optical waveguide and a diffraction grating and has a high reflectivity only for radially polarized beams, in a resonator (M. A. Ahmed, J. Schulz, A. Voss, O. Parriaux, J. C. Pommier and T. Graf: “Radially polarized 3 kW beam from a CO2 laser with an intracavity resonant grating mirror,” Opt. Lett., 32 (2007) 1824-1826.), and a method for generating a radially polarized beam using a split waveplate utilizing the refractive index anisotropy of liquid crystal molecules (https://annex.jsap.or.jp/photonics/kogaku/public/42-12-kaisetsu1.pdf).

As an original laser beam, from which the radially polarized single-beam is produced in the single-beam obtaining process, an unpolarized laser beam obtained from a fiber laser or the like, a linearly polarized laser beam obtained from a YAG laser oscillator or the like, etc. may be used depending on a method selected from the above-mentioned methods.

Further, the branching process may use for example a method using a diffractive optical element (DOE) provided with a predetermined diffraction pattern or a photonic crystal to branch the radially polarized single-beam to obtain the radially polarized multi-beam including a plurality of beamlets.

(3) In the laser welding method described in foregoing (2), branching the radially polarized single-beam may include irradiating the radially polarized single-beam to a diffraction optical element provided with a diffraction pattern for obtaining a predetermined plurality of branch beams from the radially polarized single-beam to obtain the radially polarized multi-beam.

In the laser welding method of the present technique, in the branching process, a radially polarized single-beam is irradiated to the diffraction optical element provide with the predetermined diffraction pattern to obtain a desired radially polarized multi-beam. This can therefore easily obtain the radially polarized multi-beam.

(4) The laser welding method described in any one of foregoing (1) to (3) may be configured that the first welding portion has a first facing surface, the second welding portion has a second facing surface that faces the first facing surface, the second welding portion being to be butt-welded to the first welding portion while the first facing surface and the second facing surface are butted against each other, laser-welding the first welding portion and the second welding portion is performed such that, when the irradiation site of the radially polarized multi-beam is moved forward in a first boundary extending direction, which is one of boundary extending directions in which a boundary between the first facing surface and the second facing surface extends, the plurality of beamlets forming the radially polarized multi-beam includes: one or more first front beamlets irradiated to the first welding portion to melt the first welding portion; one or more second front beamlets irradiated to the second welding portion to melt the second welding portion; and at least one inner beamlet that is moved later in the first boundary extending direction than the first front beamlets and the second front beamlets, and irradiated, on a side closer to the boundary compared to the first front beamlets and the second front beamlets, to a molten pool formed by the first welding portion melted by the first front beamlets and the second welding portion melted by the second front beamlets.

In this laser welding method, the plurality of beamlets forming the radially polarized multi-beam includes the first front side beamlet(s) and the second front side beamlet(s), the inner beamlet(s), each of which is a radial polarized beamlet. Further, the first welding portion is melted by the first front side beamlet(s) and the second welding portion is melted by the second front side beamlet(s). Moreover, the inner beamlet(s) moving forward in the first boundary extending direction later than the first and second beams is irradiated to the molten pool formed, across the boundary, by the first welding portion melted by the first front side beamlet(s) and the second welding portion melted by the second front side beamlet(s), on the side closer to the boundary than the first front side beamlet(s) and the second front side beamlet(s). Thus, the inner beamlet(s) is not allowed to pass through the gap between the first facing surface and the second facing surface and reach the opposite side (the back side) of a laser irradiation side. This can give energy to a portion closer to the boundary than the first front side beamlet and the second front side beamlet, ensuring that the first welding portion and the second welding portion are melted deeply and butt-welded to each other.

The irradiation site of the radially polarized multi-beam may be adjusted so that the inner beamlet is irradiated at the position exactly overlapping the boundary between the first facing surface and the second facing surface, which abut on each other.

The first front side beamlet(s), the second front side beamlet(s), and the inner beamlet(s) are each constituted of one or multiple beamlets. For example, the first front side beamlet, the second front side beamlet, and the inner beamlet may be each constituted of a single beamlet. Further, each of the first front side beamlet and the second front side beamlet may be constituted of a single beamlet, whereas the inner beamlets may be constituted of a plurality of (e.g., three) beamlets. Each of the first front side beamlets and the second front side beamlets may be constituted of a plurality of (e.g., three) beamlets, and the inner beamlets may also be constituted of a plurality of (e.g., five) beamlets. Moreover, for example, the number and placement of beamlets forming the first front side beamlet(s) and the second front side beamlet(s) may be set different between the first front side beamlet(s) and the second front side beamlet(s); e.g., the first front side beamlet is one beam and the second front side beamlets are two beams.

(5) In the laser welding method described in foregoing (4), furthermore, the radially polarized multi-beam may have a beam pattern in which the at least one inner beamlet has a higher beam intensity than each intensity of the first front beamlets and the second front beamlets.

In this laser welding method, the beam intensity of the inner beamlet(s) is set larger than those of the first front side beamlet(s) and the second front side beamlet(s). This can more deeply melt a part of the first welding portion and a part of second welding portion, which are located near the boundary, to form a welded portion.

(6) In the laser welding method described in foregoing (4) or (5), furthermore, it may be configured such that the first welding portion is an opening portion of a case body made of metal in a bottomed tube shape or a tube shape, the first facing surface is an opening inner peripheral surface of the opening portion of the case body, the second welding portion is a circumferential edge portion of a lid closing the opening portion, and the second facing surface is an outer peripheral surface of the circumferential edge portion of the lid.

(7) In the laser welding method described in foregoing (4) or (5), furthermore, it may be configured such that the first welding portion is an opening portion of a case body made of metal in a bottomed tube or a tube shape, the first facing surface is an opening end face of the opening portion of the case body, the second welding portion is a circumferential edge portion of a lid closing the opening portion, and the second facing surface is a one-side circumferential surface located on one side in a lid thickness direction, as a part of the circumferential edge portion of the lid.

According to those welding methods, it is possible to appropriately weld the opening portion of the case body and the circumferential edge portion of the lid closing the opening portion.

(8) Alternatively, in the laser welding method described in foregoing (4) or (5), it may be configured such that the first welding portion is a first edge portion of an unwelded case body made of a metal plate formed into a tube shape by bending, the second welding portion is a second edge portion of the unwelded case body, the second edge portion being bent to come close to the first edge portion by the bending, the first facing surface is a first end face of the first edge portion of the unwelded case body, and the second facing surface is a second end face disposed close to the first end face of the unwelded case body by the bending to face the first end face.

According to those welding methods, it is possible to form the tube-shaped case body by appropriately welding the first edge portion and the second edge portion of the unwelded case body.

(9) Another aspect of this disclosure to solve the above-mentioned problems provides a laser welding apparatus comprises: a single-beam generating optical system that generates one radially polarized single-beam; and a branching optical system that branches the one radially polarized single-beam to obtain a radially polarized multi-beam composed of a plurality of beamlets, each of the beamlets being a radially polarized beamlet.

In this laser welding apparatus, one radially polarized single-beam is generated by the single-beam generating optical system, and thereafter, the radially polarized single-beam is branched by the branching optical system to obtain the radially polarized multi-beam. This apparatus can therefore easily generate the radially polarized multi-beam.

(10) In the laser welding apparatus described in (9), furthermore, the branching optical system may be an optical system that obtains the radially polarized multi-beam by irradiating the radially polarized single-beam to a diffraction optical element provided with a diffraction pattern for obtaining a predetermined plurality of branch beams from a single beam.

In this laser welding apparatus, the branching optical system branches the radially polarized single-beam using the diffraction optical element to obtain the radially polarized multi-beam. This apparatus can easily generate the radially polarized multi-beam.

### BRIEF DESCRIPTION OF THE DRAWINGS

FIG. 1 is a perspective view of a battery in which a case body and a lid are laser-welded to each other in a first embodiment;

FIG. 2 is an explanatory diagram showing how the case body and the lid are laser-welded to each other with a radially polarized multi-beam deflected by a laser welding apparatus in the first embodiment;

FIG. 3 is an enlarged cross-sectional explanatory diagram of a part taken along a line A-A in FIG. 2, showing a state before laser-welding, in which the lid is placed in an opening portion of the case body, in the first embodiment;

FIG. 4 is an enlarged cross-sectional explanatory diagram of a part taken along a line B-B in FIG. 2, showing a state after the opening portion of the case body and a circumferential edge portion of the lid are laser-welded to each other;

FIG. 5 is an explanatory diagram showing how the opening portion of the case body and the circumferential edge portion of the lid are melted together and welded to each other with the radially polarized multi-beam in the first embodiment;

FIG. 6 is a flowchart showing each step of a laser welding method in the first to third embodiments;

FIG. 7 is an explanatory diagram showing a schematic structure of the laser welding apparatus in the first to third embodiments;

FIG. 8 is an explanatory diagram showing a polarization state of a generated beam produced by a laser oscillator of the laser welding apparatus in the first to third embodiments;

FIG. 9 is an explanatory diagram showing a polarization state of a base beam incident on an axially-symmetric polarization converting element of the laser welding apparatus in the first to third embodiments;

FIG. 10 is an explanatory diagram showing a polarization state of a radially polarized single-beam, which emerges from the axially-symmetric polarization converting element and enters the diffraction optical element in the laser welding apparatus in the first to third embodiments;

FIG. 11 is an explanatory diagram showing a beam pattern and a polarization state of a radially polarized multi-beam, which is emitted from the laser welding apparatus of the first to third embodiment and irradiated to an irradiation site;

FIG. 12 is an explanatory diagram showing a beam pattern and a polarization state of a radially polarized multi-beam in a first modified example;

FIG. 13 is an explanatory diagram showing a beam pattern and a polarization state of a radially polarized multi-beam in a second modified example;

FIG. 14 is an explanatory diagram showing a beam pattern and a polarization state of a radially polarized multi-beam in a third modified example;

FIG. 15 is an explanatory diagram showing how an unwelded case body is laser-welded with a radially polarized multi-beam deflected by the laser welding apparatus to form a case body in a second embodiment;

FIG. 16 is an enlarged cross-sectional explanatory diagram of a part taken along a line C-C in FIG. 15, showing a state of an unwelded case body before laser-welding, in which a first edge portion and a second edge portion are placed close to each other, in the second embodiment;

FIG. 17 is an enlarged cross-sectional explanatory diagram of a part taken along a line D-D in FIG. 15, showing a state after the first edge portion and the second edge portion are welded to each other, in the second embodiment;

FIG. 18 is an explanatory diagram showing how a case body and a lid are laser-welded to each other with a radially polarized multi-beam deflected by the laser welding apparatus in a third embodiment;

FIG. 19 is an enlarged cross-sectional explanatory diagram of a part taken along a line E-E in FIG. 18, showing a state before laser welding, in which an opening portion of the case body and a circumferential edge portion of the lid are placed in contact with each other in the third embodiment; and

FIG. 20 is an enlarged cross-sectional explanatory diagram of a part taken along a line F-F in FIG. 18, showing a state after the opening portion of the case body and the circumferential edge portion of the lid are laser-welded to each other in the third embodiment.

### DETAILED DESCRIPTION OF THE EXEMPLARY EMBODIMENTS

### First Embodiment

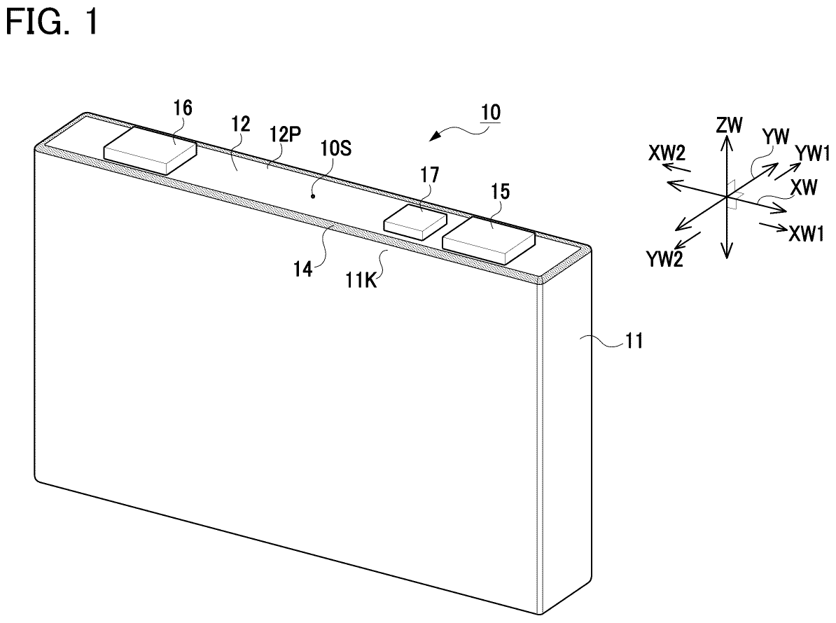

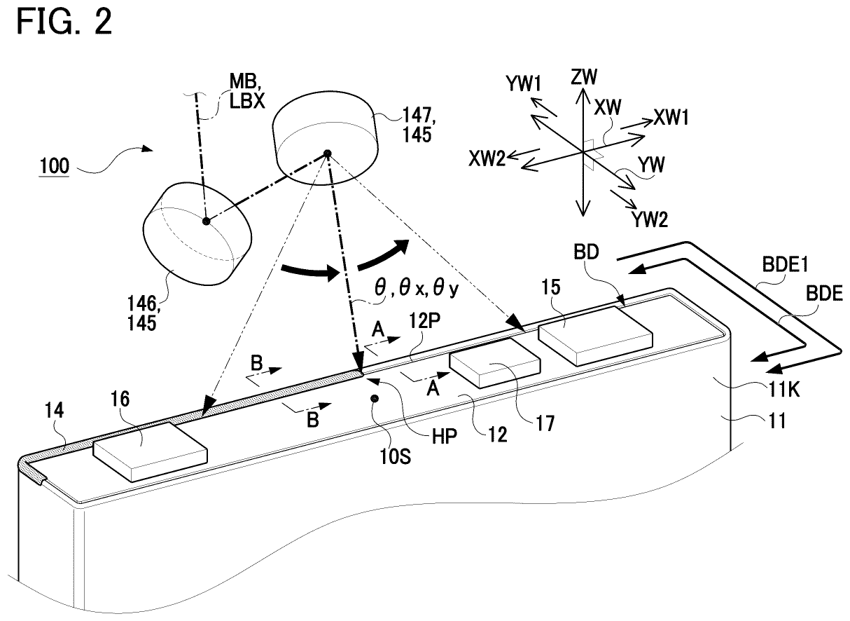

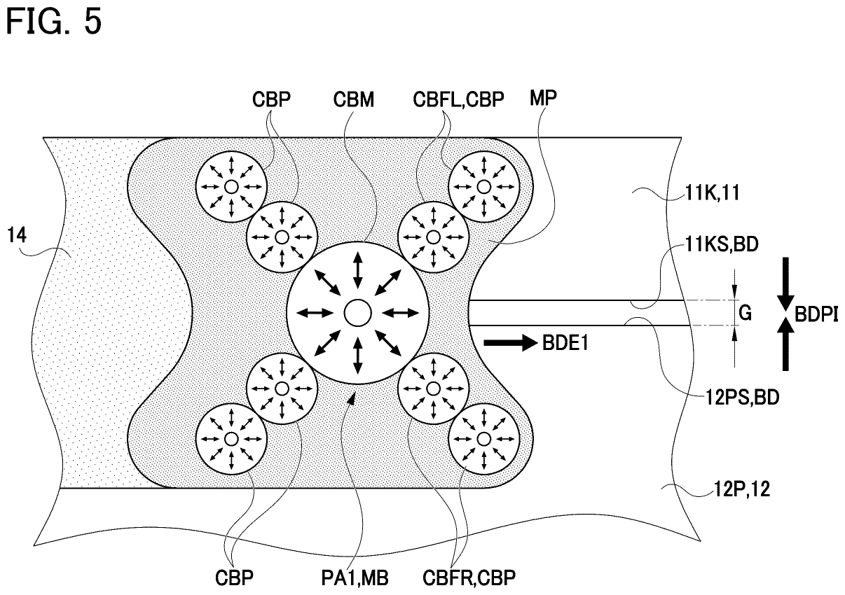

A detailed description of a first embodiment of this disclosure will now be given referring to the accompanying drawings. FIG. 1 is a perspective view of a battery 10 whose outer shape is flat, parallelepiped rectangular, including a case body 11 and a lid 12 laser-welded to each other, in the first embodiment. FIGS. 2 to 4 show how the case body 11 and the lid 12 are laser-welded to each other by deflection of a radially polarized multi-beam MB. Further, FIG. 5 shows how the case body 11 and the lid 12 are melted together and welded to each other with the radially polarized multi-beam MB.

The battery 10 is a power storage device in which the case body 11 of a bottomed rectangular tube, or prismatic, shape that is open on the upper side in FIG. 1 and a circumferential edge portion 12P of the lid 12 of a rectangular plate-like shape that is inserted in an opening portion 11K of the case body 11 to close the opening portion 11K are joined at a welded portion 14 formed by laser welding over their entire circumference as shown in FIG. 2. The case body 11 internally contains an electrode body, an electrolyte, and others not shown. A positive terminal 15 and a negative terminal 16 each extend out of the case body 11 by penetrating through the lid 12. A seal member 17 that closes a liquid inlet not shown is fixed to the lid 12, at a position between the positive terminal 15 and the negative terminal 16. This battery 10 is a secondary battery that can be charged and discharged through the positive terminal 15 and the negative terminal 16, concretely, a lithium ion secondary battery. In the present embodiment, the case body 11 and the lid 12 are each made of aluminum. In this first embodiment, three perpendicular directions related to this battery 10 are defined such that the long-side direction of the lid 12 is a work X-direction XW, the short-side direction of the same is a work Y-direction YW, and the depth direction of the case body 11 is a work Z-direction ZW, as shown in FIGS. 1 and 2.

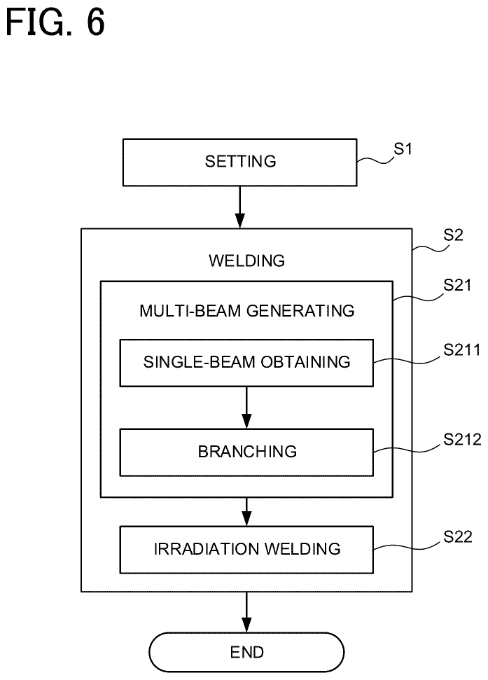

For manufacturing the battery 10 in the present embodiment, firstly, the lid 12 is inserted in the opening portion 11K of the case body 11 in a setting step S1. In a following welding step S2, a radially polarized multi-beam MB is irradiated to laser-weld the opening portion 11K of the case body 11 and the circumferential edge portion 12P of the lid 12 in a butt state (see FIG. 6).

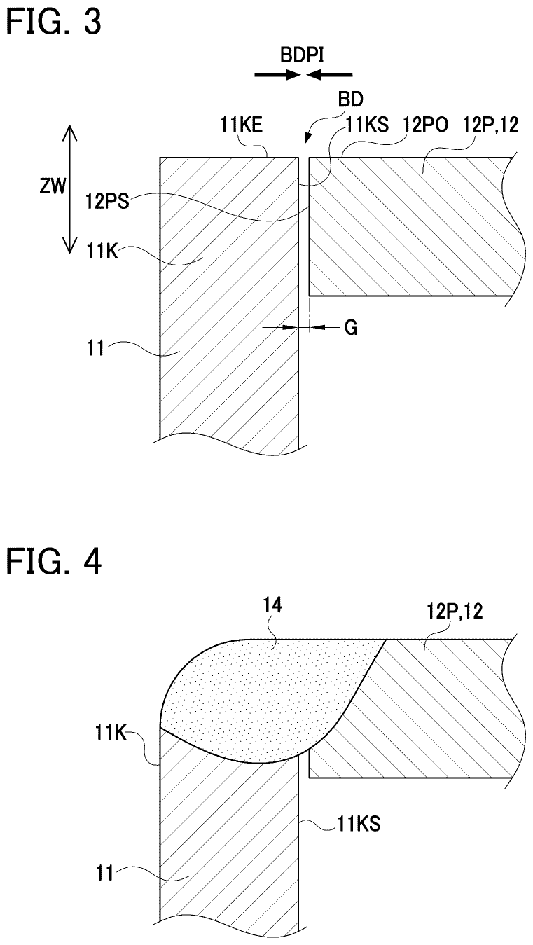

The setting step S1 (see FIG. 6) will be described first. As shown in FIGS. 1 and 2, the lid 12 is provided with the positive terminal 15 and the negative terminal 16 each formed extending out from the inside of the case body 11. These positive terminal 15 and negative terminal 16 are bonded to the electrode body not shown, which is housed in the case body 11. In the setting step S1, the electrode body bonded to the positive terminal 15 and the negative terminal 16 is inserted in the case body 11 first, and then the lid 12 is inserted in the opening portion 11K of the case body 11 (see FIG. 3). Accordingly, an opening inner peripheral surface 11KS facing inward, as a part of the opening portion 11K of the case body 11, and an outer peripheral surface 12PS facing this opening inner peripheral surface 11KS, as a part of the circumferential edge portion 12P of the lid 12, are placed at positions facing in contact with each other or facing with a slight gap G therebetween.

In the present embodiment, the lid 12 is inserted in the opening portion 11K of the case body 11 so that an opening end face 11KE of the opening portion 11K of the case body 11 and an outer surface 12PO (an upper surface in FIG. 3) of the circumferential edge portion 12P of the lid 12 coincide with each other in the work Z-direction ZW, that is, the opening end face 11KE and the outer surface 12PO are flush with each other.

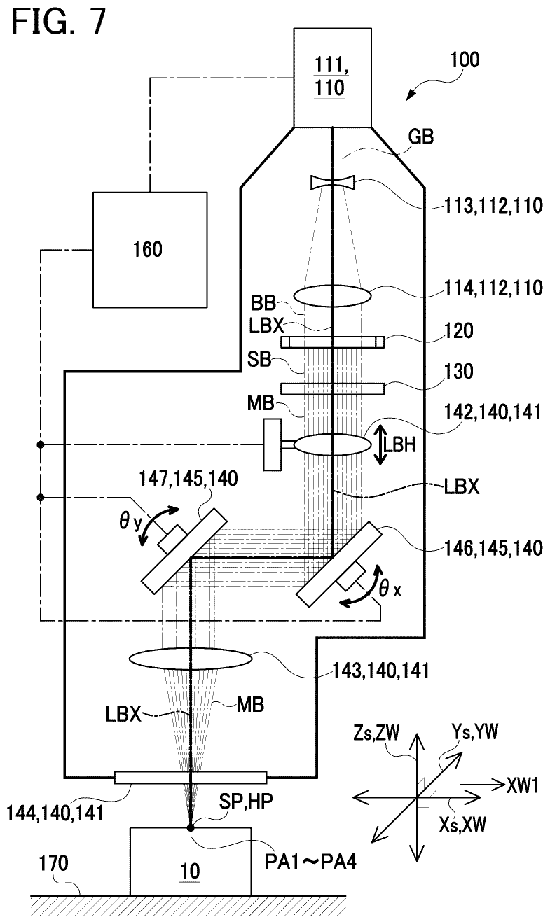

The welding step S2 is then performed. Specifically, in a multi-beam generating step S21, using a laser welding apparatus 100 (see FIG. 7) mentioned later, a laser beam is generated in the form of a radially polarized multi-beam MB composed of a plurality of (nine in the present embodiment) beamlets (sub-beams) CB, which form a beam pattern PA1 mentioned later at an irradiation site HP, and each of the beamlets is a radially polarized beamlet.

In an irradiation welding step S22, subsequently, the radially polarized multi-beam MB is irradiated to the opening portion 11K of the case body 11, which is a first portion to be welded (a first welding portion), and the circumferential edge portion 12P of the lid 12, which is a second portion to be welded (a second welding portion), of the battery 10 fixedly placed on a table surface 170 of the laser welding apparatus 100, while the irradiation site HP is moved, to laser-weld the opening portion 11K and the circumferential edge portion 12P (see FIGS. 2 to 4). Specifically, each of the opening portion 11K of the case body 11 and the circumferential edge portion 12P of the lid 12 is targeted as the irradiation site HP, and this irradiation site HP of the radially polarized multi-beam MB is moved along the boundary BD defined between the opening inner peripheral surface 11KS and the outer peripheral surface 12PS facing each other. The irradiation site HP of the radially polarized multi-beam MB is moved along a first boundary extending direction BDE1 (see FIG. 2; a clockwise direction in plan view in the present embodiment), which is one of the boundary extending directions BDE in which the boundary BD extends. In this manner, the opening portion 11K of the case body 11 and the circumferential edge portion 12P of the lid 12 are laser-welded to each other over their entire circumference along the boundary BD of a nearly rectangular ring-shape.

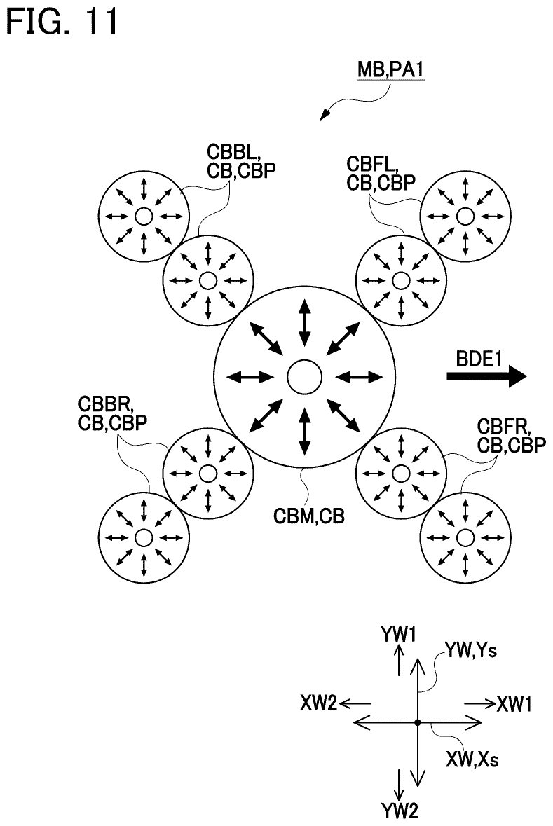

Here, the laser welding apparatus 100 of the present embodiment, used for laser welding, and the multi-beam generating step S21 performed using this laser welding apparatus 100 will be described referring to FIGS. 7 to 11. The laser welding apparatus 100 includes, as a single-beam generating optical system for generating a radially polarized single-beam SB, a light source 110 for generating a collimated, linearly polarized base beam BB (see FIG. 9) with a predetermined beam diameter and an axially-symmetric polarization converting element 120 for converting the base beam BB into one radially polarized single-beam SB (see FIG. 10). The laser welding apparatus 100 further includes a diffraction optical element 130 that is a branching optical system for branching the radially polarized single-beam SB to generate a radially polarized multi-beam MB (see FIGS. 5 and 11). This apparatus 100 further includes an optical mechanism unit 140 for irradiating the radially polarized multi-beam MB generated as above to the irradiation site HP, and a control unit 160. The optical mechanism unit 140 includes a Z-lens 142 for adjusting a focus position SP in an optical axis direction LBH along the optical axis LBX of the radially polarized multi-beam MB, and an XY scanner unit 145 for deflecting the radially polarized multi-beam MB.

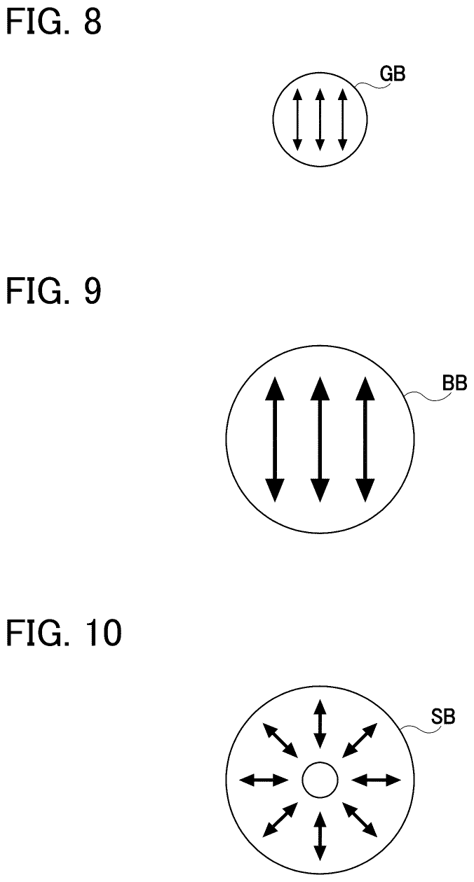

The light source 110 is constituted of a laser oscillator 111 for generating a linearly polarized, generated beam GB (see FIG. 8), and a beam expander 112 configured to expand the diameter of the generated beam GB to form a parallel base beam BB (see FIG. 9). In the present embodiment, a YAG laser is used as the laser oscillator 111. The beam expander 112 of a Galilean type includes an input lens 113, which is a concave lens, and an exit lens 114, which is a convex lens.

The linearly polarized base beam BB enters the axially-symmetric polarization converting element 120 and is converted to one radially polarized single-beam SB (see FIG. 10), as described above. The radially polarized single-beam SB used in this embodiment is a radially polarized laser beam having a single ring-shaped laser intensity distribution and an optical electric field radially generated in a radial direction. As the axially-symmetric polarization converting element 120, for example, the SWP series of axisymmetric polarization converters from Photonic Lattice and radial/azimuth polarization converters from Altekna can be used.

The radially polarized single-beam SB is made to enter the diffraction optical element 130 formed with a diffraction pattern for obtaining a predetermined plurality of branch beams from a single beam, and is converted into the radially polarized multi-beam MB. Thus, the radially polarized multi-beam MB diffracted by the diffractive optical pattern of the diffraction optical element 130 passes through the optical mechanism unit 140 and constitutes a beam pattern PA1 (see FIG. 11), in which a plurality of beamlets CB collects on the irradiation site HP (see FIG. 7) which is also a focus position SP at which the beamlets CB are focused. Each of nine beamlets CB forming the radially polarized multi-beam MB of the beam pattern PA1 is a radially polarized laser beam having a single ring-shaped laser intensity distribution, as with the radially polarized single-beam SB.

A condenser part 141 of the optical mechanism unit 140 is an optical system for adjusting the focus position SP of the radially polarized multi-beam MB emerging from the diffraction optical element 130, and includes a Z-lens 142, a condenser lens 143, and a protective glass 144. The Z-lens 142 of the condenser part 141 can move the focus position SP of the radially polarized multi-beam MB transmitting through the Z-lens 142, in the optical axis direction LBH by moving its lens part in the optical axis direction LBH (a vertical direction in FIG. 7) along the optical axis LBX.

In contrast, the XY scanner unit 145 of the optical mechanism unit 140 includes an X-deflecting part 146 composed of a Galvano scanner and a Y-deflecting part 147 similarly composed of a Galvano scanner. The X-deflecting part 146 is configured to deflect the optical axis LBX of the radially polarized multi-beam MB passing through the Z-lens 142 and entering the X-deflecting part 146, and is placed to deflect the optical axis LBX of the radially polarized multi-beam MB in a deflecting X-direction Xs along the table surface 170, on which an object to be irradiated (the battery 10 in the present embodiment) is placed, by changing the deflection angle θx of the radially polarized multi-beam MB. On the other hand, the Y-deflecting part 147 is configured to deflect the optical axis LBX of the radially polarized multi-beam MB reflected by the X-deflecting part 146, and is placed to deflect the optical axis LBX of the radially polarized multi-beam MB in a deflecting Y-direction Ys perpendicular to the deflecting X-direction Xs along the table surface 170, on which an object to be irradiated (the battery 10 in the present embodiment) is placed, by changing the deflection angle θy of the radially polarized multi-beam MB. The radially polarized multi-beam MB reflected and deflected by the Y-deflecting part 147 emerges out of the laser welding apparatus 100 via the condenser lens 143 and the protective glass 144, and comes into a focus on the focus position SP.

In the laser welding apparatus 100, therefore, the focus position SP on which the radially polarized multi-beam MB focuses is adjusted by the Z-lens 142 in a deflecting Z-direction Zs perpendicular to the deflecting X-direction Xs and the deflecting Y-direction Ys. Simultaneously, the radially polarized multi-beam MB is deflected by the XY scanner unit 145 in the deflecting X-direction Xs and the deflecting Z-direction Zs so that the radially polarized multi-beam MB is irradiated to each irradiation site HP of the object to be irradiated (e.g., the battery 10). In addition, laser welding is continuously performed by operating the Z-lens 142 and the XY scanner unit 145 to move forward the irradiation site HP of the radially polarized multi-beam MB in the first boundary extending direction BDE1 while aiming at an appropriate position, e.g., onto the boundary BD between the opening inner peripheral surface 11KS of the case body 11 and the outer peripheral surface 12PS of the lid 12.

The laser oscillator 111, Z-lens 142, and XY scanner unit 145 (X-deflecting part 146, Y-deflecting part 147) are controlled by the control unit 160 (see FIG. 7) to work in an interlocked manner with each other.

In the laser welding apparatus 100 configured as above, in the single-beam obtaining step S211 of the multi-beam generating step S21, one radially polarized single-beam SB is obtained using the light source 110 and the axially-symmetric polarization converting element 120, which constitute the single-beam generating optical system. Further, in the branching step S212, the radially polarized single-beam SB is branched by the diffraction optical element 130 constituting the branching optical system to generate the radially polarized multi-beam MB.

In the present embodiment, during laser welding on the battery 10, the battery 10 is placed and fixed on the table surface 170 so that a center point 10S of the opening portion 11K and the lid 12 of the battery 10 in the planar direction coincides with the original point in the deflecting X-direction Xs and the deflecting Y-direction Ys. Accordingly, the radially polarized multi-beam MB is deflected by the XY scanner unit 145 with the magnitude of a deflection angle θ (θx, θy) around the center point 10S, and irradiated to the irradiation site HP (see FIG. 2).

In the present embodiment, furthermore, as indicated by arrows in FIG. 7 and FIG. 2, the battery 10 is placed and fixed onto the table surface 170 so that the opening portion 11K of the case body 11 and the lid 12 are oriented upward to face the optical mechanism unit 140 (concretely, the protective glass 144) under the conditions that the work X-direction XW, corresponding to the long-side direction of the lid 12 and the lower left to upper right direction in FIG. 2, coincides with the deflecting X-direction Xs, the work Y-direction YW, corresponding to the short-side direction of the lid 12 and the upper left to lower right direction in FIG. 2, coincides with the deflecting Y-direction Ys, and the work Z-direction ZW, corresponding to the depth direction of the case body 11 and the vertical direction in FIG. 2.

Accordingly, when the optical axis LBX of the radially polarized multi-beam MB is deflected by the X-deflecting part 146, the irradiation site HP of the radially polarized multi-beam MB irradiated to the opening portion 11K of the case body 11 and the circumferential edge portion 12P of the lid 12 is moved in the work X-direction XW (i.e., the long-side direction of the lid 12) coincident with the deflecting X-direction Xs. Further, when the optical axis LBX of the radially polarized multi-beam MB is deflected by the Y-deflecting part 147, the irradiation site HP of the radially polarized multi-beam MB irradiated to the opening portion 11K and the circumferential edge portion 12P of the battery 10 is moved in the work Y-direction YW (i.e., the short-side direction of the lid 12) coincident with the deflecting Y-direction Ys.

Using this laser welding apparatus 100, the radially polarized multi-beam MB is irradiated to the opening portion 11K of the case body 11 and the circumferential edge portion 12P of the lid 12 of the battery 10 and simultaneously the irradiation site HP is moved forward in the first boundary extending direction BDE1, thereby laser-welding the opening portion 11K and the circumferential edge portion 12P over their entire circumference. The following description is given to a laser welding manner for a period during which laser welding is performed by moving the irradiation site HP of the radially polarized multi-beam MB toward one side XW1 in the work X-direction XW corresponding to the long-side direction of the lid 12, that is, for a period during which the first boundary extending direction BDE1 coincides with one way toward the one side XW1, as shown in FIG. 2.

The beam pattern PA1 (see FIG. 11) formed by the radially polarized multi-beam MB at the irradiation site HP will be described first. The beam pattern PA1 in the present embodiment is composed of nine beamlets CB. To be more specific, the beam pattern PA1 includes one main beamlet CBM located at the center, which has the highest peak energy and the largest spot diameter. In addition, around the main beamlet CBM, a total of eight surrounding beamlets CBP are radially arranged, two in each of four directions, like an X-shape. Each of these surrounding beamlets CBP has a lower peak energy and a smaller spot diameter than the main beamlet CBM.

Accordingly, when the irradiation site HP of the radially polarized multi-beam MB is moved forward to the one side XW1, or in one way coinciding with the first boundary extending direction BDE1, as indicated by a right-pointing arrow in FIG. 11, the radially polarized multi-beam MB moves forward while irradiating the main beamlet CBM and also the eight surrounding beamlets CBP at two points diagonally forward left and two points diagonally forward right, and at two point diagonally backward left and two points diagonally backward right in the traveling direction (toward the one side XW1) as seen from the main beamlet CBM.

Therefore, as shown in FIG. 5, at the irradiation site HP, the main beamlet CBM of the radially polarized multi-beam MB is positioned on the boundary BD between the opening portion 11K of the case body 11 and the circumferential edge portion 12P of the lid 12. Simultaneously, of the eight surrounding beamlets CBP, two front-left beamlets CBFL located diagonally forward left in the traveling direction as seen from the main beamlet CBM are irradiated to the opening portion 11K of the case body 11. Further, two front-right beamlets CBFR located diagonally forward right in the traveling direction as seen from the main beamlet CBM are irradiated to the circumferential edge portion 12P of the lid 12. Thus, the two front-left beamlets CBFL and the two front-right beamlets CBFR move forward in the traveling direction before the passage of the main beamlet CBM located on the boundary side BDP1, more inside than the beamlets CBFL and CBFR, and melt and merge the opening portion 11K of the case body 11 and the circumferential edge portion 12P of the lid 12 in advance, so that a molten pool is formed filling up the gap G. The molten pool thus formed can prevent the main beamlet CBM moving with a delay to later than the beamlets CBFL and CBFR from passing through the gap G and enter the case body 11, so-called “laser pass-through”.

In addition, the beam intensity of the main beamlet CBM is higher than those of the front-left beamlets CBFL and front-right beamlets CBFR. Thus, a portion of the opening portion 11K of the case body 11 and a portion of the circumferential edge portion 12P of the lid 12, near the boundary BD, can be more deeply melted, forming the welded portion 14 (see FIG. 4).

In the present embodiment, the beam pattern PA1 of the radially polarized multi-beam MB (see FIG. 11) is designed to be symmetrical at 90° (4-fold symmetry). Accordingly, even when the irradiation site HP of the radially polarized multi-beam MB is moved forward, along the opening portion 11K of the case body 11 and the circumferential edge portion 12P of the lid 12 each having a nearly rectangular shape, toward the other side YW2 in the work Y-direction YW (downward in FIG. 11), toward the other side XW2 in the work X-direction XW (rightward in FIG. 11), or toward one side YW1 in the work Y-direction YW (upward in FIG. 11), the front-left beamlets CBFL and the front-right beamlets CBFR moving earlier than the main beamlet CBM, using the same beam pattern PA1, can achieve the same effects.

Furthermore, as shown in FIG. 11, each of nine beamlets CB (i.e., the main beamlet CBM and the eight surrounding beamlets CBP) forming the radially polarized multi-beam MB is a radially polarized laser beam. Even when the radially polarized multi-beam MB is irradiated to the opening portion 11K of the case body 11 and the circumferential edge portion 12P of the lid 12 (see FIG. 2, FIG. 5), each of the beamlets CB can have a further increased absorption rate due to the increased incident angle in a depressed hole (a key hole) formed in the opening portion 11K and others melted by the beamlets CB, enabling efficient melting of the opening portion 11K and the circumferential edge portion 12P at the irradiation site HP, as compared to when beamlets that are not radially polarized, such as linearly polarized beamlets, are used. This makes it possible to more quickly weld the opening portion 11K of the case body 11 and the circumferential edge portion 12P of the lid 12 with low energy or more deeply melt and weld them with low energy.

### Modified Examples 1 to 4

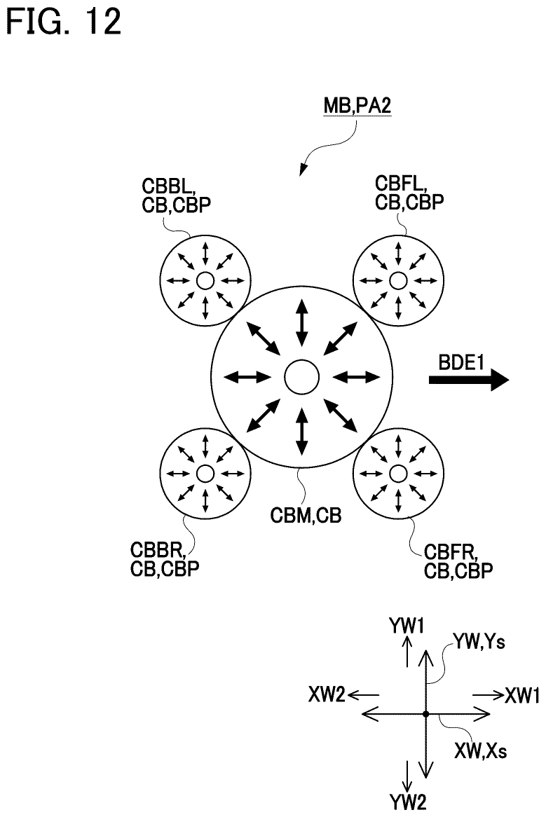

In the foregoing first embodiment, the beam pattern PA1 (see FIG. 11) composed of nine beamlets CB is used as a beam pattern of the radially polarized multi-beam MB. As an alternative, different beam patterns may be adopted. For example, beam patterns PA2 to PA4 shown in FIG. 12 to FIG. 14 may also be adopted as a beam pattern of the radially polarized multi-beam MB.

Even when each of those beam patterns PA2 to PA4 is used, when the radially polarized multi-beam MB is moved forward in the first boundary extending direction BDE1, the front-left beamlets CBFL and the front-right beamlets CBFR move ahead of the main beamlet CBM, thus melting and merging the opening portion 11K of the case body 11 and the circumferential edge portion 12P of the lid 12 to form a molten pool filling up the gap G. This can prevent or reduce the main beamlet CBM moving later than those beamlets CBFL and CBFR from passing through the gap G to enter the case body 11.

In addition, as shown in FIG. 12 to FIG. 14, each of the beamlets CB (i.e., the main beamlet CBM and the surrounding beamlets CBP) forming the radially polarized multi-beam MB is a radially polarized laser beamlet. This can therefore efficiently melt the opening portion 11K and the circumferential edge portion 12P at the irradiation site HP, as compared to when beamlets that are not radially unpolarized, such as linearly polarized beamlets, are used. This makes it possible to more quickly weld the opening portion 11K of the case body 11 and the circumferential edge portion 12P of the lid 12 with low energy or more deeply melt and weld them with low energy.

A beam pattern PA2 used in modified example 1 is composed of five beamlets CB, similar to the five-spot of a dice, as shown in FIG. 12, and is a 90°-symmetric pattern (4-fold symmetry) as with the beam pattern PA1 of the aforementioned embodiment. Thus, even when the irradiation site HP of the radially polarized multi-beam MB is moved forward toward the other side YW2 in the work Y-direction YW (downward in FIG. 11), toward the other side XW2 in the work X-direction XW (rightward in FIG. 11), or toward one side YW1 in the work Y-direction YW (upward in FIG. 11), the front-left beamlet CBFL and the front-right beamlet CBFR moving ahead earlier than the main beamlet CBM, using the same beam pattern PA2, can achieve the same effects.

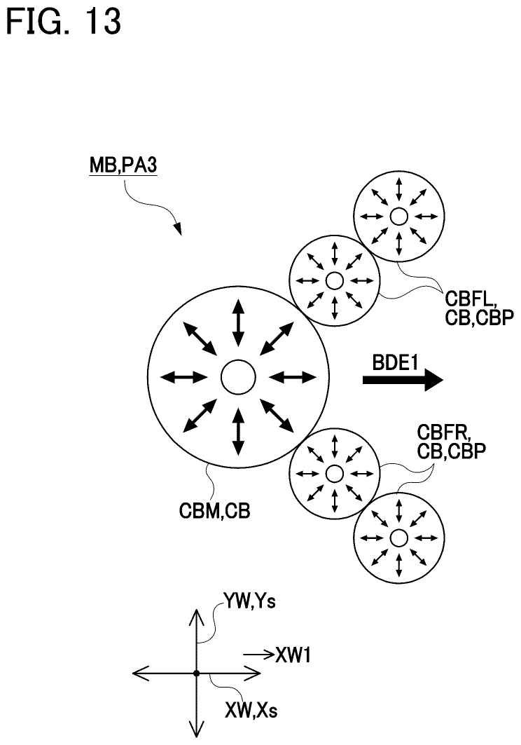

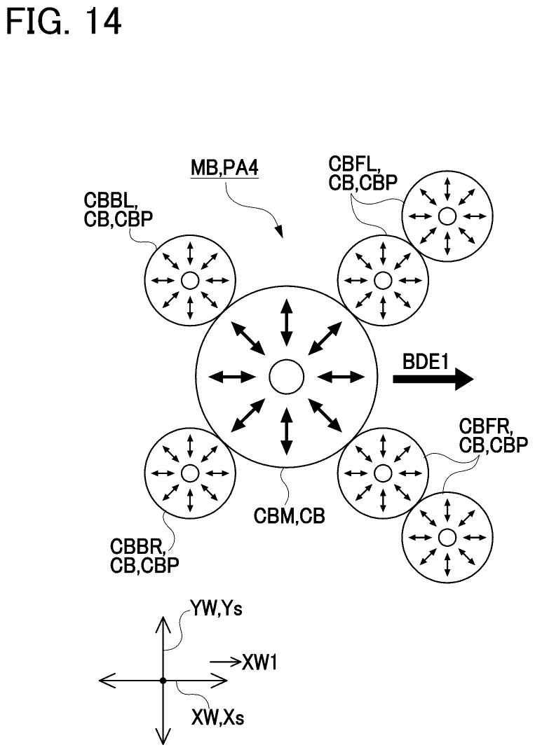

In contrast, a beam pattern PA3 used in modified example 2 shown in FIG. 13 and a beam pattern PA4 used in modified example 3 shown in FIG. 14 are convenient to move the irradiation site HP in the first boundary extending direction BDE1 indicated by an arrow in each figure.

### Second Embodiment

In the foregoing first embodiment, the opening portion 11K of the case body 11 and the circumferential edge portion 12P of the lid 12, which is separate from the case body 11, are laser-welded to each other with the radially polarized multi-beam MB (see FIG. 1 and FIG. 2).

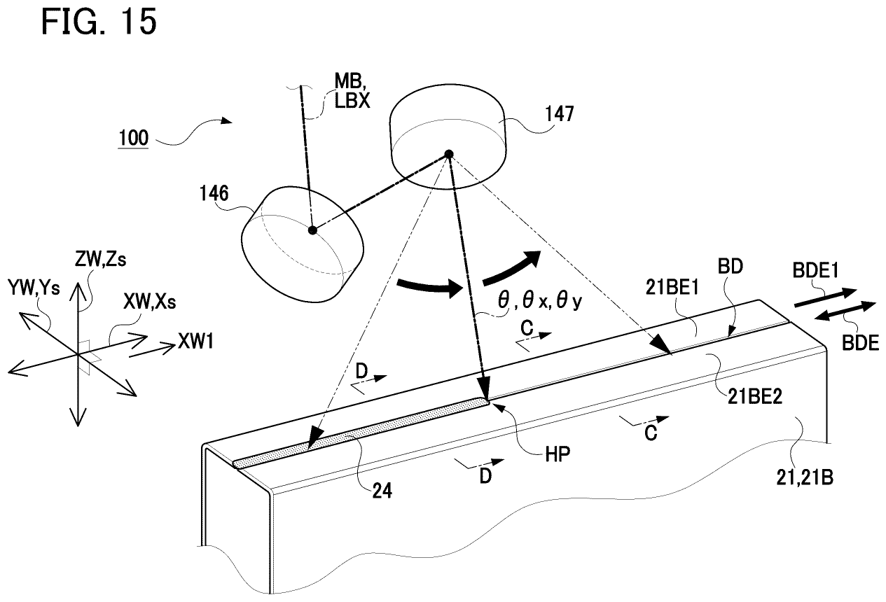

In contrast, in a second embodiment the radially polarized multi-beam MB is generated and deflected by the laser welding apparatus 100 (see FIG. 7) as in the first embodiment to laser-weld a first edge portion 21BE1, which is a first welding portion, and a second edge portion 21BE2, which is a second welding portion, of an unwelded case body 21B, which is a single body, while the first edge portion 21BE1 and second edge portion 21BE2 are butted against each other, forming a welded portion 24 (see FIG. 15 to FIG. 17). A rectangular tube, or prismatic, case body 21 is thus shaped.

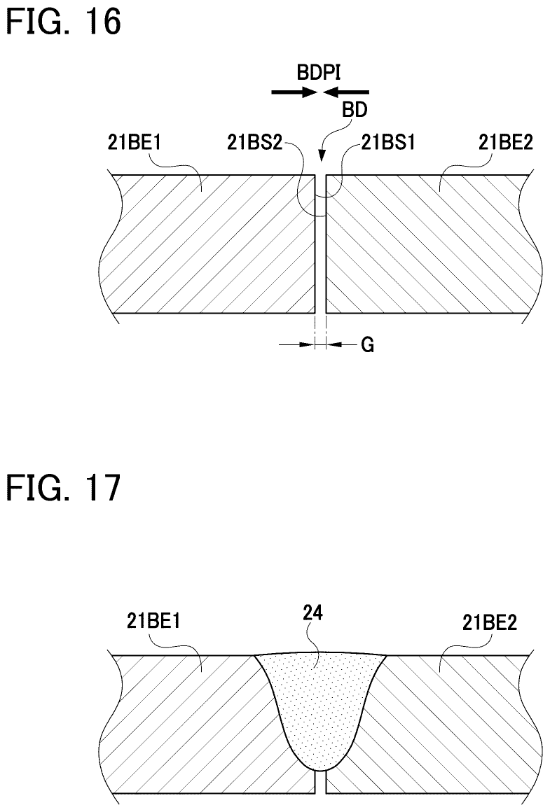

Specifically, the unwelded case body 21B is made of a rectangular aluminum plate formed into a rectangular tube, or prismatic, shape by bending. This unwelded case body 21B is bent to allow the first edge portion 21BE1 and the second edge portion 21BE2 to come close to each other (see FIG. 15 and FIG. 16). Accordingly, the second end face 21BS2 of the second edge portion 21BE2 faces the first end face 21BS1 of the first edge portion 21BE1.

In the setting step S1 (see FIG. 6), therefore, the unwelded case body 21B shaped by bending as above is prepared. In the unwelded case body 21B, the first end face 21BS1 of the first edge portion 21BE1 and the second end face 21BS2 of the second edge portion 21BE2 are located at positions facing in contact with each other or facing with a slight gap G therebetween (see FIG. 16). In the second embodiment, three perpendicular directions related to the unwelded case body 21B and the case body 21 are defined such that the long-side direction of the unwelded case body 21B is a work X-direction XW, the short-side direction of the same is a work Y-direction YW, and the depth direction of the unwelded case body 21B is a work Z-direction ZW, as shown in FIG. 15.

Subsequently, similar to the first embodiment, in the single-beam obtaining step S211 of the multi-beam generating step S21 in the welding step S2, using the laser welding apparatus 100, a radially polarized single-beam SB is obtained by use of the light source 110 and the axially-symmetric polarization converting element 120. In the branching step S212, the radially polarized multi-beam MB is obtained by use of the diffraction optical element 130.

In the irradiation welding step S22, subsequently, while the radially polarized multi-beam MB is being irradiated to the first edge portion 21BE1, which is the first welding portion, and the second edge portion 21BE2, which is the second welding portion, of the unwelded case body 21B fixedly placed on the table surface 170 of the laser welding apparatus 100, the irradiation site HP is moved to laser-weld the first edge portion 21BE1 and the second edge portion 21BE2 (see FIG. 15 to FIG. 17). More specifically, the irradiation site HP of the radially polarized multi-beam MB is moved forward along the boundary BD between the first end face 21BS1 and the second end face 21BS2 facing each other. The irradiation site HP of the radially polarized multi-beam MB here is moved forward in one of the boundary extending directions BDE of the boundary BD, that is, in the first boundary extending direction BDE1 (see FIG. 15, coinciding with one way toward the one side XW1 in the work X-direction XW in the present embodiment). In this manner, the first edge portion 21BE1 and the second edge portion 21BE2 are laser-welded together over their entire length.

Also in the second embodiment, using the radially polarized multi-beam MB of the beam pattern PA1 (see FIG. 11), two front-left beamlets CBFL and two front-right beamlets CBFR melt and merge the first edge portion 21BE1 and the second edge portion 21BE2 in advance, forming a molten pool MP filling up the gap G to prevent the main beamlet CBM moving later than the beamlets CBFL and CBFR from passing through the gap G and enter the case body 21, so-called “laser pass-through”.

In addition, the beam intensity of the main beamlet CBM is higher than those of the front-left beamlets CBFL and front-right beamlets CBFR. Thus, a portion of the first edge portion 21BE1 and a portion of the second edge portion 21BE2, near the boundary BD, can be more deeply melted, forming the welded portion 24 (see FIG. 17).

Furthermore, as shown in FIG. 11, each of the beamlets CB forming the radially polarized multi-beam MB is a radially polarized laser beamlet. This can efficiently melt the first edge portion 21BE1 and the second edge portion 21BE2, compared to when beamlets that are not radially polarized, such as linearly polarized beamlets, are used. This makes it possible to more quickly weld the first edge portion 21BE1 and the second edge portion 21BE2 with low energy or more deeply melt and weld them with low energy.

Also in the second embodiment, instead of the radially polarized multi-beam MB of the beam pattern PA1 (see FIG. 11), the radially polarized multi-beam MB of each of the beam patterns PA2 to PA4 of the modified examples 1 to 3 respectively shown in FIG. 12 to FIG. 14 may be used to laser-weld the first edge portion 21BE1 and the second edge portion 21BE2.

### Third Embodiment

In the foregoing first embodiment, in the setting step S1, the rectangular plate-shaped lid 12 is inserted in the opening portion 11K of the case body 11 having the bottomed rectangular tube, or prismatic, shape so that the opening inner peripheral surface 11KS of the opening portion 11K of the case body 11 faces the outer peripheral surface 12PS of the circumferential edge portion 12P of the lid 12. Then, in the welding step S2, the radially polarized multi-beam MB is irradiated from the outer surface 12PO side of the lid 12, laser-welding the opening portion 11K and the circumferential edge portion 12P over their entire circumference (see FIG. 1 and FIG. 2).

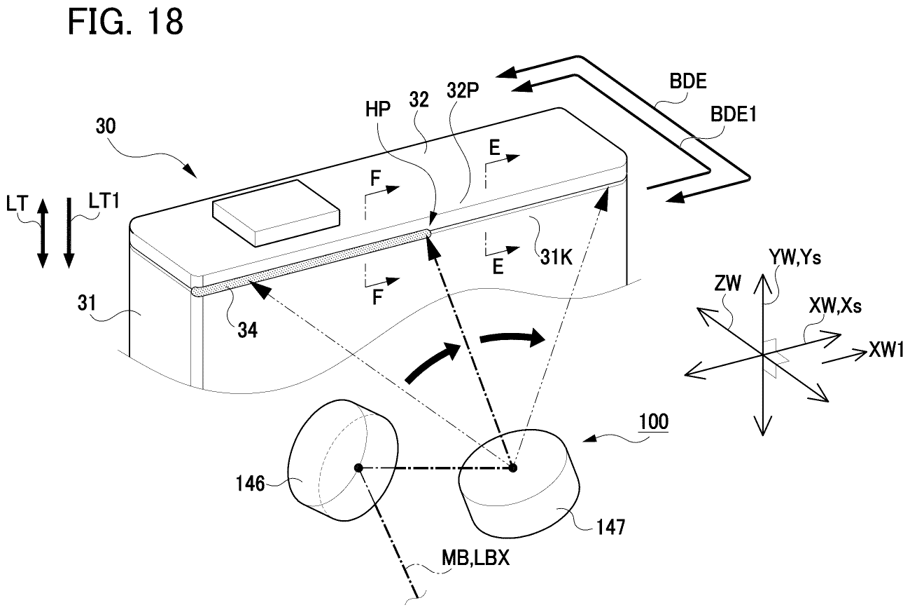

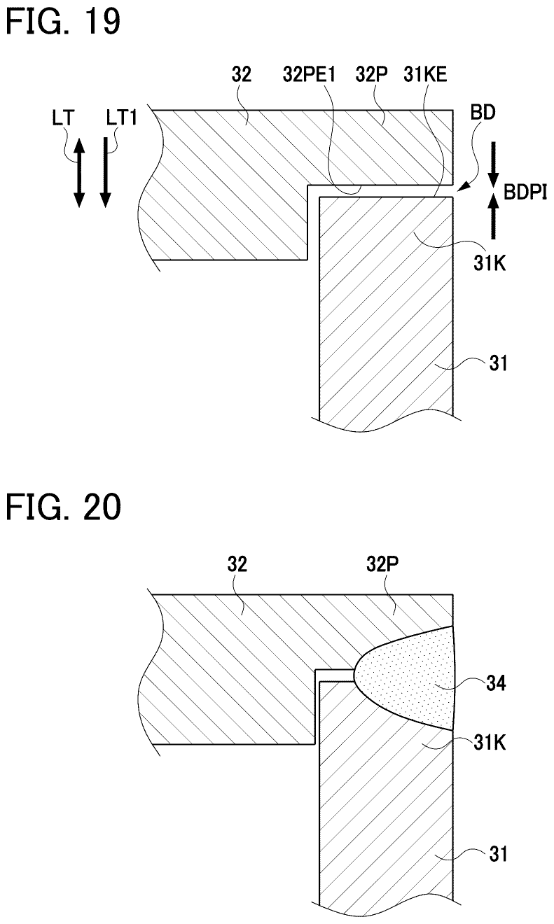

In contrast, in the third embodiment (see FIG. 18 to FIG. 20), in the setting step S1 (see FIG. 6), for a battery 30, an opening end face 31KE facing outward, as part of an opening portion 31K of a rectangular tube, or prismatic, case body 31, and a one-side circumferential surface 32PE1 facing to one side LT1 in the lid thickness direction LT (toward the case body 31), as part of a circumferential edge portion 32P of a rectangular plate-shaped lid 32 that is overlaid on the case body 31 to cover the opening portion 31K, are placed to face in contact with each other or face with a slight gap G therebetween.

In the welding step S2, the radially polarized multi-beam MB is irradiated from outside of the rectangular prismatic case body 31, laser-welding a portion of the opening portion 31K of the rectangular case body 31 and a portion of the circumferential edge portion 32P of the lid 32 along one side, for example, a long side of their entire rectangular perimeter. The following description is given to a laser welding manner for a period during which a portion of the rectangular opening portion 31K and a portion of the rectangular circumferential edge portion 32P, each corresponding to one long side located on the near side in FIG. 18, are welded together. In this period, three perpendicular directions related to the case body 31 and the lid 32 are defined such that the long-side direction of the lid 32 is a work X-direction XW, the short-side direction of the same is a work Z-direction ZW, and the depth direction of the case body 31 is a work Y-direction YW.

Subsequently, similar to the first and second embodiments, in the single-beam obtaining step S211 of the multi-beam generating step S21 in the welding step S2, using the laser welding apparatus 100, a radially polarized single-beam SB is obtained by use of the light source 110 and the axially-symmetric polarization converting element 120. Further, in the branching step S212, the radially polarized multi-beam MB is obtained by use of the diffraction optical element 130.

In the irradiation welding step S22, subsequently, while the radially polarized multi-beam MB is being irradiated to the opening portion 31K, which is the first welding portion, and the circumferential edge portion 32P, which is the second welding portion, of the case body 31 and the lid 32 fixedly placed on the table surface 170 of the laser welding apparatus 100, the irradiation site HP is moved to laser-weld the opening portion 31K and the circumferential edge portion 32P (see FIG. 18 to FIG. 20). More specifically, the irradiation site HP of the radially polarized multi-beam MB is moved forward along the boundary BD between the opening end face 31KE and the one-side circumferential surface 32PE1 facing each other. The irradiation site HP of the radially polarized multi-beam MB here is moved forward in one of the boundary extending directions BDE of the boundary BD, that is, in the first boundary extending direction BDE1 (see FIG. 18, coinciding with one way toward the one side XW1 in the work X-direction XW). In this manner, the opening portion 31K and the circumferential edge portion 32P are laser-welded together over the boundary BD along their one long side.

For remaining three sides, laser welding is performed by rotating the case body 31 and the lid 32 clockwise in plan view to laser-weld the opening portion 31K and the circumferential edge portion 32P over their full circumference.

Also in the third embodiment, using the radially polarized multi-beam MB of the beam pattern PA1 (see FIG. 11), two front-left beamlets CBFL and two front-right beamlets CBFR melt and merge the opening portion 31K and the circumferential edge portion 32P in advance, forming a molten pool MP filling up the gap G to prevent the main beamlet CBM moving later than the beamlets CBFL and CBFR from passing through the gap G and enter the case body 21, so-called “laser pass-through”.

In addition, the beam intensity of the main beamlet CBM is higher than those of the front-left beamlets CBFL and front-right beamlets CBFR. Thus, a portion of the opening portion 31K and a portion of the lid 32, near the boundary BD, can be more deeply melted, forming a welded portion 34 (see FIG. 20).

Also in the third embodiment, instead of the radially polarized multi-beam MB of the beam pattern PA1 (see FIG. 11), the radially polarized multi-beam MB of each of the beam patterns PA2 to PA4 of the modified examples 1 to 3 respectively shown in FIG. 12 to FIG. 14 may be used to laser-weld the opening portion 31K and the circumferential edge portion 32P.

The present disclosure is described in the foregoing first to third embodiments, but is not limited thereto. The present disclosure may be embodied in other specific forms without departing from the essential characteristics thereof. For example, in the first to third embodiments, to generate the radially polarized single-beam SB in the laser welding apparatus 100, the generated beam GB with linear polarization produced by the laser oscillator 111 is expanded into the base beam BB with the same linear polarization through the beam expander 112, and further converted into the radially polarized single-beam SB with radial polarization through the axially-symmetric polarization converting element 120.

However, the single-beam generating optical system only needs to generate the radially polarized single-beam SB and, for example, may be configured to generate the radially polarized single-beam SB using an unpolarized laser beam generated by a fiber laser or the like. A laser oscillator for oscillating a radially polarized laser beam may also be adopted.

As the radially polarized single-beam SB and each beamlet CB of the radially polarized multi-beam MB, a double-ring-shaped double-concentric, radially polarized beamlet may be adopted.

### REFERENCE SIGNS LIST

100 Laser welding apparatus
110 Light source (Single-beam generating optical system)
120 Axially-symmetric polarization converting element (Single-beam generating optical system)
130 Diffraction optical element (Branching optical system)
LBX Optical axis
GB Generated beam
BB Base beam
SB Radially polarized single-beam (Single beam)
MB Radially polarized multi-beam (Laser beam)
CB Radially polarized beamlet (Beamlet, Branch beam)
CBM Main beamlet (Inner beamlet)
CBP Surrounding beamlet
CBFL Front-left beamlet (First front beamlet)
CBFR Front-right beamlet (Second front beamlet)
PA1, PA2, PA3, PA4 Beam pattern
HP Irradiation site
MP Molten pool
10 Battery
11, 21, 31 Case body
11K, 31K Opening portion (First welding portion)
11KS Opening inner peripheral surface (First facing surface)
11KE Opening end face
31KE Opening end face (First facing surface)
12, 32 Lid
12P, 32P Circumferential edge portion (Second welding portion)
12PS Outer peripheral surface (Second facing surface)
12PO Outer surface
32PE1 One-side circumferential surface (Second facing surface)
LT Lid thickness direction
LT1 One side (in lid thickness direction)
14, 24, 34 Welded portion
21B Unwelded case body
21BE1 First edge portion (First welding portion)
21BE2 Second edge portion (Second welding portion)
21BS1 First end face (First facing surface)
21BS2 Second end face (Second facing surface)
30 Battery
BD Boundary
BDE Boundary extending direction
BDE1 First boundary extending direction
BDP1 Boundary side
S1 Setting step
S2 Welding step
S21 Multi-beam generating step
S211 Single-beam obtaining step
S212 Branching step
S22 Irradiation welding step

What is claimed is:

1. A laser welding method for laser-welding a first welding portion and a second welding portion by irradiation of a laser beam, the method comprising:
generating a radially polarized multi-beam as the laser beam, including a plurality of beamlets, each of the beamlets being a radially polarized beamlet; and
generating a multi-beam as the laser beam, the multi-beam being a radially polarized multi-beam including a plurality of beamlets, each of the beamlets being a radially polarized beamlet; and
laser-welding the first welding portion and the second welding portion by irradiating the radially polarized multi-beam to the first welding portion and the second welding portion and simultaneously moving an irradiation site of the radially polarized multi-beam.

2. The laser welding method according to claim 1, wherein
generating the radially polarized multi-beam includes:
obtaining one radially polarized single-beam; and
branching the radially polarized single-beam to obtain the radially polarized multi-beam.

3. The laser welding method according to claim 2, wherein
branching the radially polarized single-beam includes irradiating the radially polarized single-beam to a diffraction optical element provided with a diffraction pattern for obtaining a predetermined plurality of branch beams from the radially polarized single-beam to obtain the radially polarized multi-beam.

4. The laser welding method according to claim 1, wherein
the first welding portion has a first facing surface,
the second welding portion has a second facing surface that faces the first facing surface, the second welding portion being to be butt-welded to the first welding portion while the first facing surface and the second facing surface are butted against each other,
laser-welding the first welding portion and the second welding portion is performed such that,
when the irradiation site of the radially polarized multi-beam is moved forward in a first boundary extending direction, which is one of boundary extending directions in which a boundary between the first facing surface and the second facing surface extends,
the plurality of beamlets forming the radially polarized multi-beam includes:
one or more first front beamlets irradiated to the first welding portion to melt the first welding portion;
one or more second front beamlets irradiated to the second welding portion to melt the second welding portion; and
at least one inner beamlet that is moved later in the first boundary extending direction than the first front beamlets and the second front beamlets, and irradiated, on a side closer to the boundary compared to the first front beamlets and the second front beamlets, to a molten pool formed by the first welding portion melted by the first front beamlets and the second welding portion melted by the second front beamlets.

5. The laser welding method according to claim 2, wherein
the first welding portion has a first facing surface,
the second welding portion has a second facing surface that faces the first facing surface, the second welding portion being to be butt-welded to the first welding portion while the first facing surface and the second facing surface are butted against each other,
laser-welding the first welding portion and the second welding portion is performed such that,
when the irradiation site of the radially polarized multi-beam is moved forward in a first boundary extending direction, which is one of boundary extending directions in which a boundary between the first facing surface and the second facing surface extends,
the plurality of beamlets forming the radially polarized multi-beam includes:
one or more first front beamlets irradiated to the first welding portion to melt the first welding portion;
one or more second front beamlets irradiated to the second welding portion to melt the second welding portion; and
at least one inner beamlet that is moved later in the first boundary extending direction than the first front beamlets and the second front beamlets, and irradiated, on a side closer to the boundary compared to the first front beamlets and the second front beamlets, to a molten pool formed by the first welding portion melted by the first front beamlets and the second welding portion melted by the second front beamlets.

6. The laser welding method according to claim 3, wherein
the first welding portion has a first facing surface,
the second welding portion has a second facing surface that faces the first facing surface, the second welding portion being to be butt-welded to the first welding portion while the first facing surface and the second facing surface are butted against each other,
laser-welding the first welding portion and the second welding portion is performed such that,
when the irradiation site of the radially polarized multi-beam is moved forward in a first boundary extending direction, which is one of boundary extending directions in which a boundary between the first facing surface and the second facing surface extends,
the plurality of beamlets forming the radially polarized multi-beam includes:
one or more first front beamlets irradiated to the first welding portion to melt the first welding portion;
one or more second front beamlets irradiated to the second welding portion to melt the second welding portion; and
at least one inner beamlet that is moved later in the first boundary extending direction than the first front beamlets and the second front beamlets, and irradiated, on a side closer to the boundary compared to the first front beamlets and the second front beamlets, to a molten pool formed by the first welding portion melted by the first front beamlets and the second welding portion melted by the second front beamlets.

7. The laser welding method according to claim 4, wherein the radially polarized multi-beam has a beam pattern in which the at least one inner beamlet has a higher beam intensity than each intensity of the first front beamlets and the second front beamlets.

8. The laser welding method according to claim 5, wherein beamlet has a higher beam intensity than each intensity of the first front beamlets and the second front beamlets.

9. The laser welding method according to claim 6, wherein beamlet has a higher beam intensity than each intensity of the first front beamlets and the second front beamlets.

10. The laser welding method according to claim 4, wherein
the first welding portion is an opening portion of a case body made of metal in a bottomed tube shape or a tube shape,
the first facing surface is an opening inner peripheral surface of the opening portion of the case body,
the second welding portion is a circumferential edge portion of a lid closing the opening portion, and
the second facing surface is an outer peripheral surface of the circumferential edge portion of the lid.

11. The laser welding method according to claim 7, wherein
the first welding portion is an opening portion of a case body made of metal in a bottomed tube shape or a tube shape,
the first facing surface is an opening inner peripheral surface of the opening portion of the case body,
the second welding portion is a circumferential edge portion of a lid closing the opening portion, and
the second facing surface is an outer peripheral surface of the circumferential edge portion of the lid.

12. The laser welding method according to claim 4, wherein
the first welding portion is an opening portion of a case body made of metal in a bottomed tube or a tube shape,
the first facing surface is an opening end face of the opening portion of the case body,
the second welding portion is a circumferential edge portion of a lid closing the opening portion, and
the second facing surface is a one-side circumferential surface located on one side in a lid thickness direction, as a part of the circumferential edge portion of the lid.

13. The laser welding method according to claim 7, wherein
the first welding portion is an opening portion of a case body made of metal in a bottomed tube or a tube shape,
the first facing surface is an opening end face of the opening portion of the case body,
the second welding portion is a circumferential edge portion of a lid closing the opening portion, and
the second facing surface is a one-side circumferential surface located on one side in a lid thickness direction, as a part of the circumferential edge portion of the lid.

14. The laser welding method according to claim 4, wherein
the first welding portion is a first edge portion of an unwelded case body made of a metal plate formed into a tube shape by bending,
the second welding portion is a second edge portion of the unwelded case body, the second edge portion being bent to come close to the first edge portion by the bending,
the first facing surface is a first end face of the first edge portion of the unwelded case body, and
the second facing surface is a second end face disposed close to the first end face of the unwelded case body by the bending to face the first end face.

15. The laser welding method according to claim 7, wherein
the first welding portion is a first edge portion of an unwelded case body made of a metal plate formed into a tube shape by bending,
the second welding portion is a second edge portion of the unwelded case body, the second edge portion being bent to come close to the first edge portion by the bending,
the first facing surface is a first end face of the first edge portion of the unwelded case body, and
the second facing surface is a second end face disposed close to the first end face of the unwelded case body by the bending to face the first end face.

16. A laser welding apparatus comprises:
a single-beam generating optical system that generates one radially polarized single-beam; and
a branching optical system that branches the one radially polarized single-beam to obtain a radially polarized multi-beam composed of a plurality of beamlets, each of the beamlets being a radially polarized beamlet.

17. The laser welding apparatus according to claim 16, wherein the branching optical system is an optical system that obtains the radially polarized multi-beam by irradiating the radially polarized single-beam to a diffraction optical element provided with a diffraction pattern for obtaining a predetermined plurality of branch beams from a single beam.
